(19) United States
(12) Patent Application Publication
(10) Pub. No.: US 2026/0288500 A1
(43) Pub. Date: Sep. 24, 2026

(54) In-house Inquiry Response System

(71) Applicant: SoftBank Group Corp., Tokyo (JP)

(72) Inventor: Shinya KURANO, Tokyo (JP)

(21) Appl. No.: 19/568,819

(22) Filed: Mar. 17, 2026

Related U.S. Application Data
(60) Provisional application No. 63/774,786, filed on Mar. 20, 2025.

(51) Int. Cl. G06F 9/451; H04L 9/40

(52) U.S. Cl. CPC G06F 9/453; H04L 63/0272

(57) ABSTRACT

The present disclosure relates to a system for improving efficiency and automating in-house help desk services. This system uses an AI model that operates via a cloud service, analyzes inquiries from employees with natural language processing technology, and generates prompt and accurate primary responses. The system includes an information processing unit, a data management unit, a security unit, an escalation management unit, an inquiry processing unit, and a business flow management unit, and each unit functions in cooperation. The data management unit centrally manages in-house information and provides it to the AI model. The security unit restricts access using a virtual network and ensures information security. The escalation management unit transfers inquiries that the AI cannot handle to a person in charge, and the business flow management unit supports the business processes of employees.

### CROSS-REFERENCE TO RELATED APPLICATION

This application claims the benefit of priority from U.S. Provisional Patent Application No. 63/774786, filed on Mar. 20, 2025. The entire contents of the priority application are incorporated herein by reference.

### BACKGROUND

The technology of the present disclosure relates to a system.

Japanese Unexamined Patent Publication No. 2022-180282 discloses a method, which is a persona chatbot control method performed by at least one processor, the method including a step of receiving a user utterance, a step of adding the user utterance to a prompt including an instruction sentence associated with a description regarding a character of a chatbot, a step of encoding the prompt, and a step of inputting the encoded prompt to a language model to generate a chatbot utterance responding to the user utterance.

### SUMMARY

A problem to be solved by this disclosure is efficiency improvement and automation of help desk services for employees within a company. In conventional help desk services, employees and contract employees often respond manually, which required a great deal of time and effort to handle inquiries. In addition, because the content of inquiries is diverse, the burden on the person in charge was large, and variations in the quality of responses sometimes occurred. Furthermore, depending on the content of the inquiry, escalation to a person in charge with specialized knowledge was necessary, which sometimes caused delays in response.

This disclosure aims to solve these problems by automating help desk services using AI technology. By using an AI model, it becomes possible to provide prompt and consistent answers to inquiries from employees. In addition, for complex inquiries that the AI cannot handle, it is possible to hand them over to the appropriate person in charge through an efficient escalation process. As a result, it is expected that the efficiency of help desk services will improve and employee satisfaction will increase.

Furthermore, since this system operates securely within an in-house network using a cloud service, it is possible to achieve automation by AI while preventing the leakage of confidential information. This makes it possible to improve the overall business efficiency of the company and contribute to cost reduction.

As a means for solving the problem, the present disclosure provides a system for automating in-house help desk services. This system has an information processing unit including an AI model that operates within an in-house network via a cloud service, and thereby, it becomes possible to generate prompt and consistent primary responses to inquiries from employees. Furthermore, the system includes a security unit that restricts access from the outside using a virtual network, and can securely manage confidential information within the company.

In addition, the system includes a data management unit that causes an AI model to read various in-house information, thereby providing a foundation for the AI model to generate appropriate answers based on the content of inquiries. The inquiry processing unit has a function of analyzing the content of inquiries from employees using natural language processing technology and generating a primary response based on information read in advance. This enables a prompter response compared to conventional manual responses.

Furthermore, for complex inquiries that the AI model cannot handle, an escalation management unit automatically escalates them to a system administrator. This escalation process is efficiently performed by a specialized method and is designed to minimize the burden on the person in charge. Finally, a business flow management unit manages a new business flow in which employees accept responses from the AI and perform escalation as necessary, and supports the adaptation of employees to the business process. This realizes efficiency improvement of in-house help desk services and improvement of employee satisfaction.

### BRIEF DESCRIPTION OF DRAWINGS

FIG. 1 is a conceptual diagram illustrating an example of a configuration of a data processing system according to a first embodiment.

FIG. 2 is a conceptual diagram illustrating an example of main functions of a data processing apparatus and a smart device according to the first embodiment.

FIG. 3 is a conceptual diagram illustrating an example of a configuration of a data processing system according to a second embodiment.

FIG. 4 is a conceptual diagram illustrating an example of main functions of a data processing apparatus and smart glasses according to the second embodiment.

FIG. 5 is a conceptual diagram illustrating an example of a configuration of a data processing system according to a third embodiment.

FIG. 6 is a conceptual diagram illustrating an example of main functions of a data processing apparatus and a headset-type terminal according to the third embodiment.

FIG. 7 is a conceptual diagram illustrating an example of a configuration of a data processing system according to a fourth embodiment.

FIG. 8 is a conceptual diagram illustrating an example of main functions of a data processing apparatus and a robot according to the fourth embodiment.

FIG. 9 illustrates an emotion map on which a plurality of emotions are mapped.

FIG. 10 illustrates an emotion map on which a plurality of emotions are mapped.

FIG. 11 is a flowchart illustrating an example of an in-house inquiry response method.

### DETAILED DESCRIPTION

Hereinafter, an example of an embodiment of a system according to the technology of the present disclosure will be described with reference to the accompanying drawings.

First, terms used in the following description will be described.

In the following embodiments, a processor with a reference sign (hereinafter, simply referred to as a “processor”) may be one arithmetic device or may be a combination of a plurality of arithmetic devices. Also, the processor may be one type of arithmetic device or may be a combination of a plurality of types of arithmetic devices. Examples of the arithmetic device include a CPU (Central Processing Unit), a GPU (Graphics Processing Unit), a GPGPU (General-Purpose computing on Graphics Processing Units), an APU (Accelerated Processing Unit), and the like.

In the following embodiments, a RAM (Random Access Memory) with a reference sign is a memory in which information is temporarily stored, and is used as a work memory by a processor.

In the following embodiments, a storage with a reference sign is one or more non-volatile storage devices that store various programs, various parameters, and the like. Examples of the non-volatile storage device include a flash memory (SSD (Solid State Drive)), a magnetic disk (for example, a hard disk), or a magnetic tape, and the like.

In the following embodiments, a communication I/F (Interface) with a reference sign is an interface including a communication processor, an antenna, and the like. The communication I/F manages communication among a plurality of computers. An example of a communication standard applied to the communication I/F includes a wireless communication standard including 5G (5th Generation Mobile Communication System), Wi-Fi (registered trademark), or Bluetooth (registered trademark), and the like.

In the following embodiments, “A and/or B” is synonymous with “at least one of A and B”. That is, “A and/or B” means that it may be A only, B only, or a combination of A and B. Also, in the present specification, when three or more matters are expressed by being connected with “and/or”, the same concept as “A and/or B” is applied.

### First Embodiment

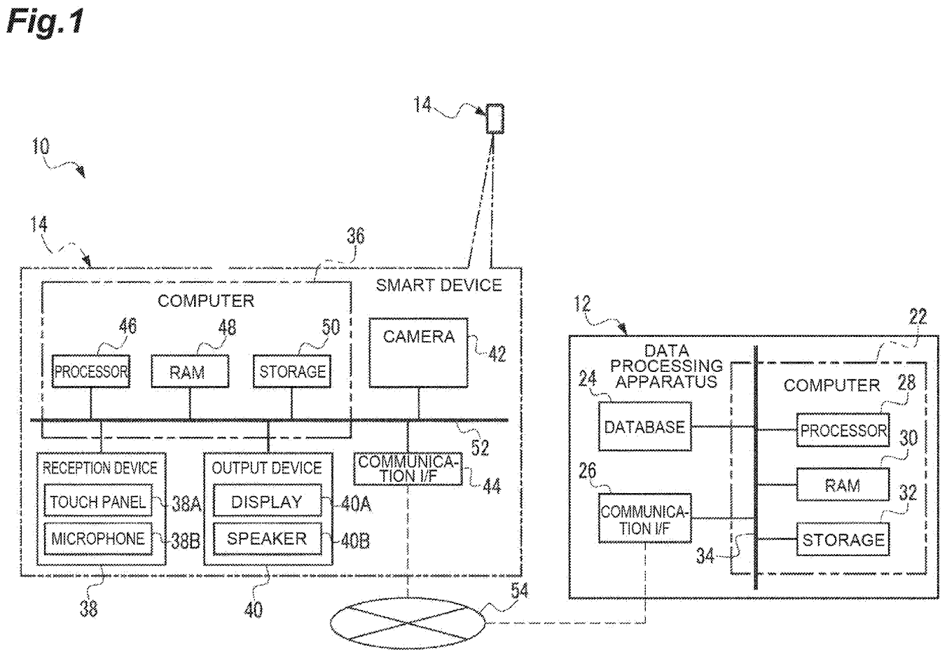

FIG. 1 illustrates an example of a configuration of a data processing system 10 according to a first embodiment.

As illustrated in FIG. 1, the data processing system 10 includes a data processing apparatus 12 and a smart device 14. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart device 14 includes a computer 36, a reception device 38, an output device 40, a camera 42, and a communication I/F 44. The computer 36 includes a processor 46, a RAM 48, and a storage 50. The processor 46, the RAM 48, and the storage 50 are connected to a bus 52. Also, the reception device 38, the output device 40, and the camera 42 are also connected to the bus 52.

The reception device 38 includes a touch panel 38A, a microphone 38B, and the like, and receives a user input. The touch panel 38A receives a user input by contact of an indicator by detecting contact of the indicator (for example, a pen or a finger, etc.). The microphone 38B receives a user input by voice by detecting a user's voice. A control unit 46A transmits data indicating the user input received by the touch panel 38A and the microphone 38B to the data processing apparatus 12. In the data processing apparatus 12, a specific processing unit 290 acquires the data indicating the user input.

The output device 40 includes a display 40A, a speaker 40B, and the like, and presents data to a user 20 by outputting the data in a representation form (for example, voice and/or text) perceivable by the user 20. The display 40A displays visible information such as text and images in accordance with an instruction from the processor 46. The speaker 40B outputs voice in accordance with an instruction from the processor 46. The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted.

The communication I/F 44 is connected to the network 54. The communication I/Fs 44 and 26 manage exchange of various information between the processor 46 and the processor 28 via the network 54.

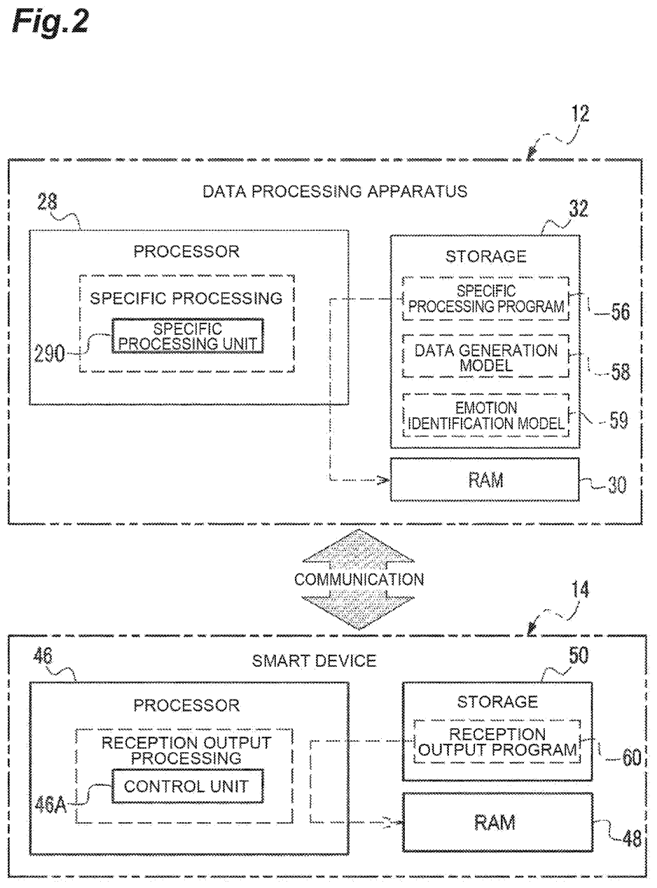

FIG. 2 illustrates an example of main functions of the data processing apparatus 12 and the smart device 14.

As illustrated in FIG. 2, in the data processing apparatus 12, specific processing is performed by the processor 28. A specific processing program 56 is stored in the storage 32. The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but the present disclosure is not limited to such an example. Also, the estimation and prediction of emotion include, for example, analysis (analytics) of emotion and the like.

In the smart device 14, reception output processing is performed by the processor 46. A reception output program 60 is stored in the storage 50. The reception output program 60 is used in combination with the specific processing program 56 by the data processing system 10. The processor 46 reads the reception output program 60 from the storage 50 and executes the read reception output program 60 on the RAM 48. The specific processing is realized by the processor 46 operating as a control unit 46A in accordance with the specific processing program 60 executed on the RAM 48. Note that the smart device 14 can also have a data generation model and an emotion identification model similar to the data generation model 58 and the emotion identification model 59, and perform processing similar to that of the specific processing unit 290 using these models. The reception output processing is realized by the processor 46 operating as the control unit 46A in accordance with the reception output program 60 executed on the RAM 48.

Note that an apparatus other than the data processing apparatus 12 may have the data generation model 58. For example, a server apparatus (for example, a generation server) may have the data generation model 58. In this case, the data processing apparatus 12 obtains a processing result (such as a prediction result) in which the data generation model 58 is used, by communicating with the server apparatus having the data generation model 58. Also, the data processing apparatus 12 may be a server apparatus, or may be a terminal device owned by a user (for example, a mobile phone, a robot, a home appliance, etc.). Next, an example of processing by the data processing system 10 according to the first embodiment will be described.

### Example 1

A flow of specific processing in Example 1 will be described. Each unit of the system described below is realized by the data processing apparatus 12 and the smart device 14. Also, the data processing apparatus 12 is referred to as a “server”, and the smart device 14 is referred to as a “terminal”.

### Embodiment

An embodiment will be described more specifically and in detail. This system is realized using a server and a terminal, and each unit fulfills its respective role to improve efficiency and automate in-house help desk services.

First, an information processing unit in the server operates an AI model via a cloud service. The information processing unit may be configured by, for example, the specific processing unit 290, the specific processing program 56, the data generation model 58, and the emotion identification model 59. This AI model makes full use of natural language processing technology to analyze inquiries from employees. For example, when an employee inquires, “Please tell me how to check my salary statement,” the AI model analyzes this inquiry, extracts the corresponding information from the in-house salary management system manual or FAQ, and generates a specific procedure as a response. Through this process, employees can quickly obtain necessary information.

A data management unit is responsible for centrally managing various in-house information on the server and providing it to the AI model. The data management unit may be configured by, for example, the specific processing unit 290, the specific processing program 56, the data generation model 58, the emotion identification model 59, and the database 24. For example, when a new in-house regulation is enacted, the data management unit immediately updates that information and reflects it in the AI model. This allows the AI model to always generate answers based on the latest information. In addition, the data management unit performs version control of information and also enables access to past information, thereby realizing appropriate information provision according to the content of the inquiry.

A security unit strictly restricts external access to the server using a virtual network. The security unit may be configured by, for example, the specific processing unit 290, the specific processing program 56, the data generation model 58, and the emotion identification model 59. For example, it prevents unauthorized access from the outside by making settings that allow access only within the in-house network. In addition, it is provided with a function to record access logs in detail and immediately notify an administrator when an abnormal access pattern is detected. This makes it possible to minimize the risk of confidential information leakage.

The security unit is provided with a PII (Personally Identifiable Information) filtering function for personal information protection and confidentiality. Specifically, before transmitting a prompt to the AI model (especially an external AI model on the cloud), confidential information such as employee names, phone numbers, and IP addresses is detected using a regular expression or a Named Entity Recognition (NER) model, and these are replaced (masked) with random tokens or hash values. After receiving a response from the AI model, the security unit restores (demasks) the replaced tokens to the original information and presents it to the employee. With this configuration, even while using an external cloud service, the leakage of confidential information outside the in-house network is cryptographically and physically blocked.

An escalation management unit has a function of escalating complex inquiries that the AI model cannot handle to a system administrator (a terminal of a system administrator, an administrator terminal). Note that “escalation” refers to a series of technical control processes in which, when a first processing entity (for example, an AI model or an autonomous control program) determines that it cannot execute an input task or that the confidence level of a processing result falls below a predetermined threshold, the processing authority for the task and related context information (dialogue history, error logs, state variables, etc.) are automatically transferred to a second processing entity (for example, a human administrator, a specialized operator, or a higher-level supervisory system) for seamless handover. The escalation management unit may be configured by, for example, the specific processing unit 290, the specific processing program 56, the data generation model 58, and the emotion identification model 59. For example, if the AI model cannot generate an appropriate response to an inquiry such as “A server connection error has occurred,” the escalation management unit automatically notifies the person in charge in the IT department and requests a detailed investigation and response. This process is provided with a function to set the priority of escalation, enabling a prompt response according to the degree of urgency.

The escalation management unit includes an evaluation module that calculates a confidence score of the response generated by the AI model. The evaluation module calculates the score based on a probability distribution for each token of the generated response or a similarity with extracted context information. When the confidence score is less than a predetermined threshold (for example, 0.7), the escalation management unit performs control to interrupt or suspend the generation of the response and immediately transmit an alert signal to the terminal of the system administrator. This prevents the spread of inaccurate information in advance and suppresses wasteful consumption of calculation resources and network bandwidth by filtering only cases requiring human judgment.

An inquiry processing unit in the terminal provides an interface for employees to input inquiries and receive answers from the AI model. The inquiry processing unit may be configured by, for example, the reception device 38 and the output device 40. For example, employees can easily make inquiries through a desktop application or a mobile app. The interface adopts an intuitive design and is designed so that employees can operate it smoothly. In addition, an option for confirming the answer from the AI model and performing escalation as necessary is also provided.

The inquiry processing unit and the information processing unit may adopt a Retrieval-Augmented Generation (RAG) architecture. Specifically, the data management unit divides text data such as in-house regulations and manuals into a predetermined token length, converts (vectorizes) it into high-dimensional vector data using an embedding model, and stores it in a vector database. The inquiry processing unit similarly vectorizes an inquiry sentence from an employee, performs a neighborhood search such as cosine similarity calculation on the vector database, and extracts context information semantically highly relevant to the content of the inquiry. Then, the information processing unit inputs a prompt combining the inquiry sentence and the extracted context information to the AI model (large language model). This suppresses hallucination of the AI model and enables high-precision response generation based on facts specific to the company.

A business flow management unit manages a new business flow in which employees accept responses from the AI and perform escalation as necessary. For example, if an employee is satisfied with the AI's answer, they can proceed with their work as is, and if they are not satisfied, they can choose to escalate. This flow supports the adaptation of employees to the business process and enables efficient work execution. In addition, the business flow management unit can record the inquiry history of employees and use it to improve future inquiry responses.

As described above, the embodiment of the present disclosure realizes efficiency improvement and automation of in-house help desk services by combining a server and a terminal, and contributes to the improvement of employee satisfaction. By having each unit function in cooperation, it becomes possible to provide prompt and accurate information, and it is expected that the overall business efficiency of the company will be improved.

### System Configuration

The system according to the present embodiment includes an information processing unit, a data management unit, a security unit, an escalation management unit, an inquiry processing unit, and a business flow management unit. The information processing unit has a function of operating an AI model via a cloud service. This AI model analyzes inquiries from employees using natural language processing technology and generates an appropriate primary response. For example, when an employee inquires, “Please tell me the application procedure for a new project,” the AI model refers to the in-house project management manual and related procedure guidelines and provides a specific procedure as a response. Also, in response to an inquiry such as “I want to know how to apply for leave,” it generates a response based on the usage method of the leave management system and examples of filling out the application form. Furthermore, in the case of “I want to check the schedule of an in-house event,” it provides a response by referring to the event calendar and past event information. A specific example of a prompt sentence to be read into the AI model is, “Please analyze the content of the inquiry from the employee and generate an appropriate response based on the relevant in-house information.”

The data management unit is responsible for centrally managing various in-house information and providing it to the AI model. For example, when a new in-house regulation is enacted, the data management unit immediately updates that information and reflects it in the AI model. This allows the AI model to always generate answers based on the latest information. In addition, the data management unit performs version control of information and also enables access to past information, thereby realizing appropriate information provision according to the content of the inquiry. Furthermore, the data management unit integrates information provided from each department in the company and constructs a database for the AI model to refer to. This database includes, for example, in-house personnel information, financial data, technical documents, and the like.

The security unit strictly restricts external access to the server using a virtual network. For example, it prevents unauthorized access from the outside by making settings that allow access only within the in-house network. In addition, it is provided with a function to record access logs in detail and immediately notify an administrator when an abnormal access pattern is detected. This makes it possible to minimize the risk of confidential information leakage. Furthermore, the security unit enhances information security by introducing data encryption and multi-factor authentication.

The escalation management unit has a function of escalating complex inquiries that the AI model cannot handle to a system administrator. For example, if the AI model cannot generate an appropriate response to an inquiry such as “A server connection error has occurred,” the escalation management unit automatically notifies the person in charge in the IT department and requests a detailed investigation and response. This process is provided with a function to set the priority of escalation, enabling a prompt response according to the degree of urgency. In addition, the escalation management unit records the history of escalations and uses it for future improvements.

The inquiry processing unit provides an interface for employees to input inquiries and receive answers from the AI model. For example, employees can easily make inquiries through a desktop application or a mobile app. The interface adopts an intuitive design and is designed so that employees can operate it smoothly. In addition, an option for confirming the answer from the AI model and performing escalation as necessary is also provided. Furthermore, the inquiry processing unit records the inquiry history of employees and uses it to improve future inquiry responses.

The business flow management unit manages a new business flow in which employees accept responses from the AI and perform escalation as necessary. For example, if an employee is satisfied with the AI's answer, they can proceed with their work as is, and if they are not satisfied, they can choose to escalate. This flow supports the adaptation of employees to the business process and enables efficient work execution. In addition, the business flow management unit analyzes points for improvement in the business flow and contributes to improving the efficiency of the entire system. Furthermore, the business flow management unit collects feedback from employees and reflects it in system improvements.

### Implementation Steps

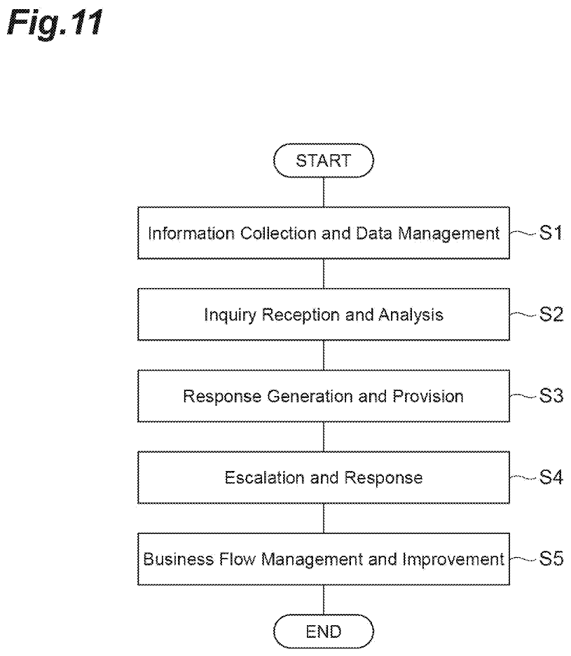

### Step 1: Information Collection and Data Management (See Step S1 in FIG. 11)

In this step, the data management unit collects various in-house information and constructs a database for the AI model to refer to. For example, when a new in-house regulation is enacted, the data management unit immediately updates that information and reflects it in the AI model. This allows the AI model to always generate answers based on the latest information. In addition, the data management unit performs version control of information and also enables access to past information, thereby realizing appropriate information provision according to the content of the inquiry. Furthermore, it integrates information provided from each department in the company and constructs a database for the AI model to refer to. This database includes, for example, in-house personnel information, financial data, technical documents, and the like.

### Step 2: Inquiry Reception and Analysis (See Step S2 in FIG. 11)

When an employee makes an inquiry through a terminal, the inquiry processing unit receives the content. For example, when an employee inquires, “Please tell me the application procedure for a new project,” the inquiry processing unit transmits the content to the AI model. The AI model analyzes the content of the inquiry using natural language processing technology and generates an appropriate primary response. At this time, a specific example of a prompt sentence to be read into the generative AI is, “Please analyze the content of the inquiry from the employee and generate an appropriate response based on the relevant in-house information.”

### Step 3: Response Generation and Provision (See Step S3 in FIG. 11)

After analyzing the content of the inquiry, the AI model generates a primary response based on the information provided from the data management unit. For example, the AI model refers to the in-house project management manual and related procedure guidelines and provides a specific procedure as a response. Also, in response to an inquiry such as “I want to know how to apply for leave,” it generates a response based on the usage method of the leave management system and examples of filling out the application form. Furthermore, in the case of “I want to check the schedule of an in-house event,” it provides a response by referring to the event calendar and past event information.

### Step 4: Escalation and Response (See Step S4 in FIG. 11)

For complex inquiries that the AI model cannot handle, the escalation management unit automatically escalates them to a system administrator. For example, if the AI model cannot generate an appropriate response to an inquiry such as “A server connection error has occurred,” the escalation management unit automatically notifies the person in charge in the IT department and requests a detailed investigation and response. This process is provided with a function to set the priority of escalation, enabling a prompt response according to the degree of urgency. In addition, the escalation management unit records the history of escalations and uses it for future improvements.

### Step 5: Business Flow Management and Improvement (See Step S5 in FIG. 11)

The business flow management unit manages a new business flow in which employees accept responses from the AI and perform escalation as necessary. For example, if an employee is satisfied with the AI's answer, they can proceed with their work as is, and if they are not satisfied, they can choose to escalate. This flow supports the adaptation of employees to the business process and enables efficient work execution. In addition, the business flow management unit analyzes points for improvement in the business flow and contributes to improving the efficiency of the entire system. Furthermore, the business flow management unit collects feedback from employees and reflects it in system improvements.

### Specific Use Case

For example, a case is assumed where an employee in a certain company needs to perform an application procedure for a new project. This employee accesses the in-house help desk system using a terminal and inputs “Please tell me the application procedure for a new project” through the inquiry processing unit. This inquiry is transmitted to the information processing unit, and the AI model performs analysis using natural language processing technology.

The AI model refers to the in-house project management manual and related procedure guidelines provided by the data management unit and generates a specific procedure as a response. The generated response is, for example, “Please download the project application form, fill in the necessary items, obtain your supervisor's approval, and then upload it to the project management system.” This response is provided to the employee through the inquiry processing unit, and the employee can proceed with the procedure according to the instructions.

In this process, a specific example of a prompt sentence to be read into the generative AI is, “Please analyze the content of the inquiry from the employee and generate an appropriate response based on the relevant in-house information.” Based on this prompt, the AI model extracts the information most relevant to the content of the inquiry and provides an accurate and prompt response.

Furthermore, if the employee is not satisfied with the provided response, or if a complex inquiry that the AI model cannot handle occurs, the escalation management unit automatically escalates it to a system administrator. For example, if a specific technical problem related to a project application occurs, the escalation management unit notifies the person in charge in the IT department and requests a detailed investigation and response. This escalation process is performed promptly according to the priority and supports the smooth progress of the employee's work.

In this way, the system of the present disclosure can provide prompt and accurate answers to employee inquiries, improve business efficiency, and, by performing appropriate escalation as necessary, improve the overall business efficiency of the company.

### Application Example 1

A flow of specific processing in Application Example 1 will be described. Each unit of the system described below is realized by the data processing apparatus 12 and the smart device 14. Also, the data processing apparatus 12 is referred to as a “server”, and the smart device 14 is referred to as a “terminal”.

### Embodiment

An embodiment will be described more specifically and in detail. This system is designed to improve the efficiency of inventory management, shipping instructions, and delivery planning in a logistics center, and includes an information processing unit, a data management unit, and a delivery planning unit.

First, the information processing unit is responsible for collecting and analyzing various data within the logistics center in real time. Specifically, it collects inventory data, shipping information, and traffic condition data using sensors and barcode readers. For example, when goods arrive, product information is read with a barcode reader and registered in the inventory database. This data includes the type of product, quantity, arrival date, storage location, and the like. In addition, shipping information includes order details, scheduled shipping date, delivery destination information, and the like. Traffic condition data is acquired from an external traffic information provision service and is updated in real time.

The information processing unit analyzes these data using natural language processing technology and generates optimal inventory placement, shipping instructions, and delivery routes. For example, if the turnover rate of a product is high, it is recommended to place it near the shipping area to improve the efficiency of picking work. Specifically, based on past shipping history, frequently shipped products are placed at the front of the picking zone to minimize the travel distance of workers. In addition, products with a low shipping frequency are placed in the back of the warehouse to effectively utilize space. In this way, the information processing unit optimizes inventory placement.

The generation of inventory placement and shipping instructions by the information processing unit is converted into control signals for physical transport equipment. For example, the system is communicably connected to an Automated Guided Vehicle (AGV) or an Automated Storage and Retrieval System (AS/RS) in the warehouse. When the information processing unit determines “product relocation,” the determination is converted into a movement command (movement path coordinates and lift operation signal) to the AGV, and the AGV physically moves the product. As a result, the calculation result is directly reflected in the object manipulation in the physical space without human cognitive judgment, and the logistics efficiency in the warehouse is optimized at the physical level. [0070] Next, the data management unit centrally manages various data within the logistics center and provides it to the information processing unit. For example, it manages data such as product barcode information, incoming/outgoing history, and inventory levels, and provides it to the information processing unit as needed. The data management unit performs regular data updates to ensure the accuracy of the information and also makes past data available for reference. This allows the information processing unit to always perform analysis based on the latest and most accurate data. Furthermore, the data management unit regularly backs up the data to prevent data loss or damage.

The delivery planning unit optimizes the operation of delivery vehicles based on the delivery routes generated by the information processing unit. For example, it shortens delivery times by selecting routes that avoid traffic jams, taking traffic condition data into account. In addition, it reduces fuel costs by selecting the shortest route based on the geographical information of the delivery destination. Furthermore, it monitors the condition of delivery vehicles and adjusts the operation plan when maintenance is required. In this way, the delivery planning unit realizes efficient delivery. Specifically, it utilizes GPS data of delivery vehicles to grasp the real-time position of the vehicles and dynamically adjusts the optimal route.

The delivery planning unit acquires GPS data from delivery vehicles and traffic congestion information from an external traffic API at predetermined time intervals (e.g., every 30 seconds), and recalculates the total cost (time or fuel) of the remaining delivery route using a route search algorithm based on graph theory (e.g., Dijkstra's algorithm or A* algorithm). As a result of the recalculation, if an alternative route with a cost lower than the current route by a predetermined value or more is found, the delivery planning unit transmits a route change command to the navigation device of the delivery vehicle by push notification. This process can include dynamic swapping of delivery destinations between multiple delivery vehicles, and maximizes the operation rate of the entire vehicle group by solving the overall optimization problem in real time. The delivery planning unit may be configured by, for example, the specific processing unit 290, the specific processing program 56, the data generation model 58, and the emotion identification model 59.

As a specific example, in a certain logistics center, an AI model analyzes product arrival information and generates a proposal to optimize inventory placement. For example, when seasonal products arrive, the AI model predicts the demand for those products and preferentially places them in areas where demand is expected to be high. In addition, for shipping instructions, the AI model analyzes the order details and ships multiple orders to the same delivery destination together, thereby increasing the efficiency of packing work. Furthermore, in delivery planning, the AI model utilizes real-time traffic information to generate an optimal delivery route, thereby shortening delivery times and improving customer satisfaction.

In this way, the embodiment of the present disclosure can improve the efficiency of inventory management, shipping instructions, and delivery planning in a logistics center, and improve overall business efficiency. This is expected to lead to a reduction in the operating costs of the logistics center and an improvement in service quality.

### System Configuration

The system according to the present embodiment includes an information processing unit, a data management unit, and a delivery planning unit. The information processing unit is responsible for collecting and analyzing various data within the logistics center in real time. Specifically, it collects inventory data, shipping information, and traffic condition data using sensors and barcode readers. For example, when goods arrive, product information is read with a barcode reader and registered in the inventory database. This data includes the type of product, quantity, arrival date, storage location, and the like. In addition, shipping information includes order details, scheduled shipping date, delivery destination information, and the like. Traffic condition data is acquired from an external traffic information provision service and is updated in real time. The information processing unit analyzes these data using natural language processing technology and generates optimal inventory placement, shipping instructions, and delivery routes. For example, if the turnover rate of a product is high, it is recommended to place it near the shipping area to improve the efficiency of picking work. Specifically, based on past shipping history, frequently shipped products are placed at the front of the picking zone to minimize the travel distance of workers. In addition, products with a low shipping frequency are placed in the back of the warehouse to effectively utilize space. In this way, the information processing unit optimizes inventory placement.

The data management unit centrally manages various data within the logistics center and provides it to the information processing unit. For example, it manages data such as product barcode information, incoming/outgoing history, and inventory levels, and provides it to the information processing unit as needed. The data management unit performs regular data updates to ensure the accuracy of the information and also makes past data available for reference. This allows the information processing unit to always perform analysis based on the latest and most accurate data. Furthermore, the data management unit regularly backs up the data to prevent data loss or damage. For example, it automatically performs a backup after the end of daily operations and saves it to a different physical storage, enabling data recovery in the event of a disaster. In addition, the data management unit sets access rights and ensures data security. For example, by setting specific data to be accessible only by administrators, information leakage is prevented.

The delivery planning unit optimizes the operation of delivery vehicles based on the delivery routes generated by the information processing unit. For example, it shortens delivery times by selecting routes that avoid traffic jams, taking traffic condition data into account. In addition, it reduces fuel costs by selecting the shortest route based on the geographical information of the delivery destination. Furthermore, it monitors the condition of delivery vehicles and adjusts the operation plan when maintenance is required. In this way, the delivery planning unit realizes efficient delivery. Specifically, it utilizes GPS data of delivery vehicles to grasp the real-time position of the vehicles and dynamically adjusts the optimal route. For example, if a traffic jam occurs due to a sudden traffic accident, it immediately proposes an alternative route to minimize delivery delays. In addition, the delivery planning unit optimizes the load capacity of delivery vehicles and supports efficient delivery. For example, if there are multiple delivery destinations, it determines the optimal delivery order considering the load capacity and reduces unnecessary travel.

In this way, the system according to the present embodiment can improve the efficiency of inventory management, shipping instructions, and delivery planning in a logistics center, and improve overall business efficiency. A specific example of a prompt sentence to be read into the generative AI is, “Please analyze the inventory data and shipping information in the logistics center and generate optimal inventory placement and shipping instructions.” Based on this prompt, the AI model provides information to support efficient logistics operations. This is expected to lead to a reduction in the operating costs of the logistics center and an improvement in service quality.

### Implementation Steps

### Step 1: Data Collection and Registration

Data collection within the logistics center is performed using a barcode reader when goods arrive. Product information is registered in the inventory database as detailed data including the type of product, quantity, arrival date, storage location, and the like. Shipping information includes order details, scheduled shipping date, and delivery destination information, and these serve as the basic data for shipping instructions. Traffic condition data is acquired in real time from an external traffic information provision service and is utilized for delivery planning.

### Step 2: Data Management and Update

The data management unit centrally manages various data within the logistics center and performs regular data updates to ensure the accuracy of the information. For example, it automatically performs a backup after the end of daily operations and saves it to a different physical storage, enabling data recovery in the event of a disaster. In addition, it sets access rights and ensures data security. Specific data is set to be accessible only by administrators, preventing information leakage.

### Step 3: Optimization of Inventory Placement

The information processing unit analyzes the collected inventory data using natural language processing technology and proposes optimal inventory placement. If the turnover rate of a product is high, it is recommended to place it near the shipping area to improve the efficiency of picking work. Specifically, frequently shipped products are placed at the front of the picking zone to minimize the travel distance of workers. A specific example of a prompt sentence to be read into the generative AI is, “Please analyze the inventory data and propose optimal inventory placement.”

### Step 4: Generation of Shipping Instructions

The information processing unit analyzes the order details and determines the optimal shipping order. For example, it increases the efficiency of packing work by shipping multiple orders to the same delivery destination together. Shipping instructions are optimized according to the size and weight of the products and the priority of the delivery destination. This improves the efficiency of shipping work and is expected to reduce shipping errors.

### Step 5: Optimization of Delivery Planning

The delivery planning unit optimizes the operation of delivery vehicles based on the delivery routes generated by the information processing unit. It shortens delivery times by selecting routes that avoid traffic jams, taking traffic condition data into account. In addition, it reduces fuel costs by selecting the shortest route based on the geographical information of the delivery destination. It utilizes GPS data of delivery vehicles to grasp the real-time position of the vehicles and dynamically adjusts the optimal route.

### Specific Use Case

For example, in a certain logistics center, the system of the present disclosure is utilized during a period when the arrival of seasonal products increases. This system collects product arrival information in real time through the information processing unit and registers it in the inventory database. When detailed data such as the type, quantity, arrival date, and storage location of the arrived products are registered, the information processing unit analyzes these data and proposes optimal inventory placement.

Specifically, if the turnover rate of a product is high, it is recommended to place it near the shipping area to improve the efficiency of picking work. For example, based on past shipping history, frequently shipped products are placed at the front of the picking zone to minimize the travel distance of workers. In addition, products with a low shipping frequency are placed in the back of the warehouse to effectively utilize space. In this way, the optimization of inventory placement is achieved.

Next, for shipping instructions, the information processing unit analyzes the order details and determines the optimal shipping order. For example, it increases the efficiency of packing work by shipping multiple orders to the same delivery destination together. Shipping instructions are optimized according to the size and weight of the products and the priority of the delivery destination. This improves the efficiency of shipping work and is expected to reduce shipping errors.

Furthermore, in delivery planning, the delivery planning unit generates an optimal delivery route, taking traffic condition data into account. For example, it shortens delivery times by utilizing real-time traffic information to avoid traffic jams. In addition, it reduces fuel costs by selecting the shortest route based on the geographical information of the delivery destination. It utilizes GPS data of delivery vehicles to grasp the real-time position of the vehicles and dynamically adjusts the optimal route.

In this process, a specific example of a prompt sentence to be read into the generative AI is, “Please analyze the inventory data and shipping information in the logistics center and generate optimal inventory placement and shipping instructions.” Based on this prompt, the AI model provides information to support efficient logistics operations.

In this way, the system of the present disclosure can improve the efficiency of inventory management, shipping instructions, and delivery planning in a logistics center, and improve overall business efficiency. This is expected to lead to a reduction in the operating costs of the logistics center and an improvement in service quality.

The specific processing unit 290 transmits a result of the specific processing to the smart device 14. In the smart device 14, the control unit 46A causes the output device 40 to output the result of the specific processing. The microphone 38B acquires voice indicating a user input for the result of the specific processing. The control unit 46A transmits voice data indicating the user input acquired by the microphone 38B to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL:https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

The data generation model 58 may be implemented not only on the server (cloud) side but also on the smart device 14 (edge side) as a lightweight model (e.g., a quantized distilled model). In this case, the specific processing unit 290 determines the complexity of the input data or the quality of the communication environment, and dynamically switches whether to perform processing in the cloud or at the edge (offloading control). For example, in cases where communication delay exceeds an allowable range or where processing requiring high privacy is involved, inference is performed using the lightweight model on the edge side. This provides technical effects of reducing network load and improving real-time performance.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the smart device 14.

### Second Embodiment

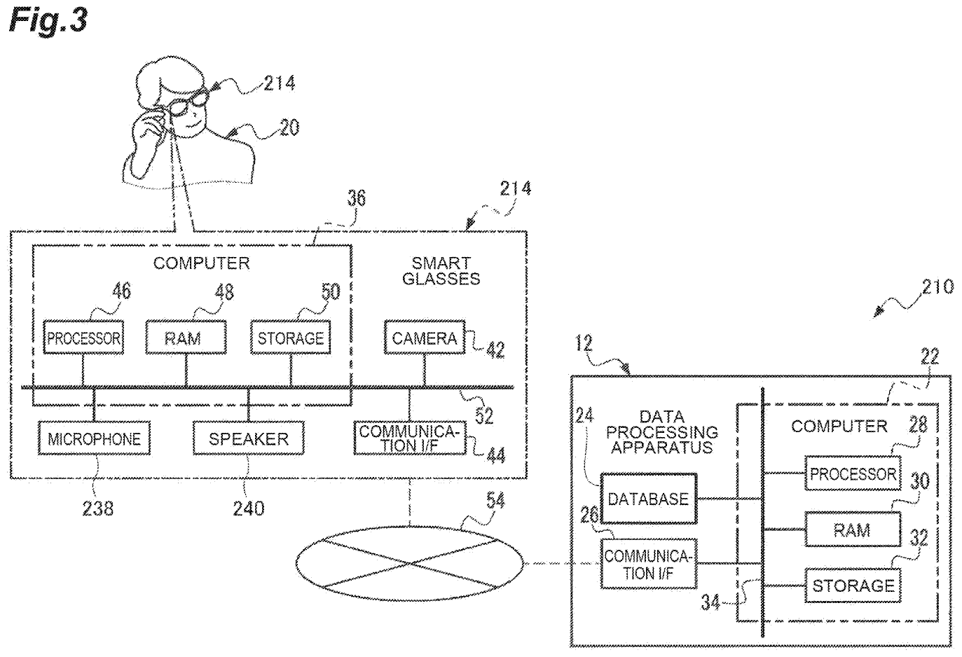

FIG. 3 illustrates an example of a configuration of a data processing system 210 according to a second embodiment.

As illustrated in FIG. 3, the data processing system 210 includes a data processing apparatus 12 and smart glasses 214. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart glasses 214 include a computer 36, a microphone 238, a speaker 240, a camera 42, and a communication I/F 44. The computer 36 includes a processor 46, a RAM 48, and a storage 50. The processor 46, the RAM 48, and the storage 50 are connected to a bus 52. Also, the microphone 238, the speaker 240, and the camera 42 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

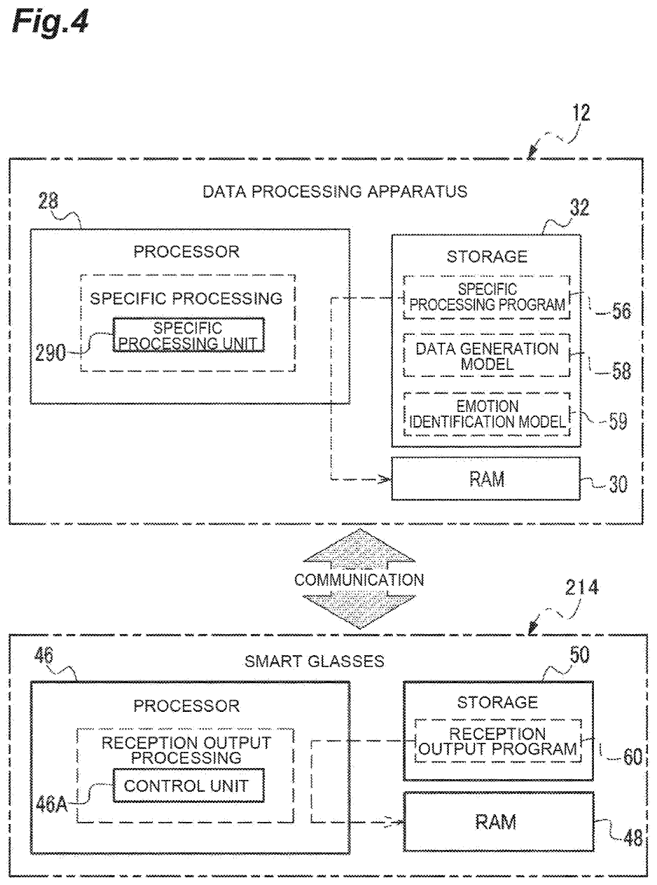

FIG. 4 illustrates an example of main functions of the data processing apparatus 12 and the smart glasses 214. As illustrated in FIG. 4, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but the present disclosure is not limited to such an example. Also, the estimation and prediction of emotion include, for example, analysis (analytics) of emotion and the like.

In the smart glasses 214, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48. Note that the smart glasses 214 can also have a data generation model and an emotion identification model similar to the data generation model 58 and the emotion identification model 59, and perform processing similar to that of the specific processing unit 290 using these models.

Next, specific processing by the specific processing unit 290 of the data processing apparatus 12 will be described. Each unit of the system described below is realized by the data processing apparatus 12 and the smart glasses 214. In the following description, the data processing apparatus 12 is referred to as a “server”, and the smart glasses 214 are referred to as a “terminal”.

### Example 1

Since the flow of the specific processing is the same as that in Example 1 described in the first embodiment, a description thereof is omitted.

### Application Example 1

Since the flow of the specific processing is the same as that in Example 1 described in the first embodiment, a description thereof is omitted.

The specific processing unit 290 transmits a result of the specific processing to the smart glasses 214. In the smart glasses 214, the control unit 46A causes the speaker 240 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL:https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the smart glasses 214.

### Third Embodiment

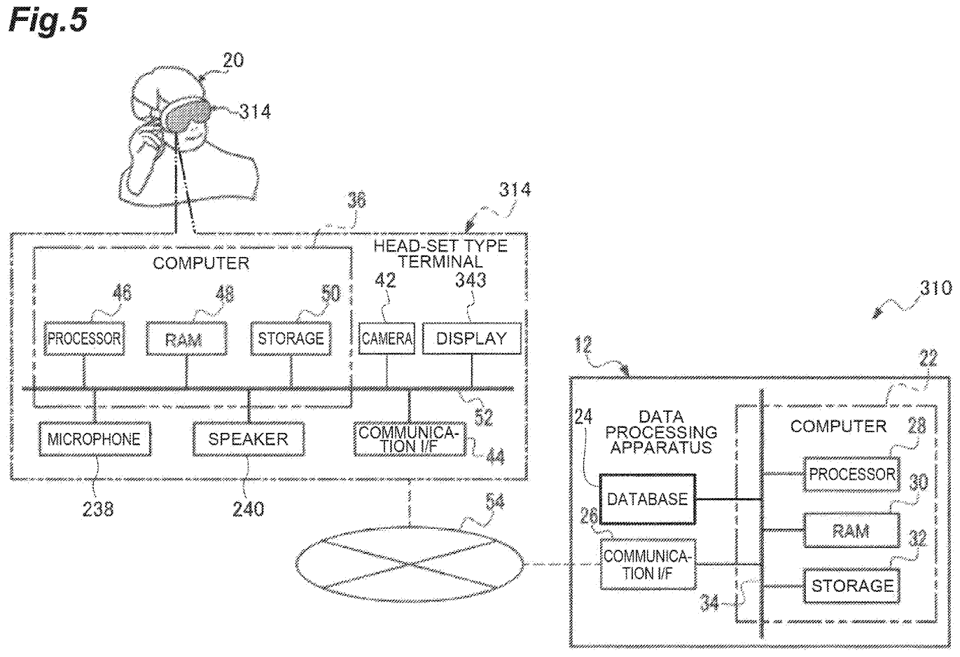

FIG. 5 illustrates an example of a configuration of a data processing system 310 according to a third embodiment.

As illustrated in FIG. 5, the data processing system 310 includes a data processing apparatus 12 and a headset-type terminal 314. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The headset-type terminal 314 includes a computer 36, a microphone 238, a speaker 240, a camera 42, a communication I/F 44, and a display 343. The computer 36 includes a processor 46, a RAM 48, and a storage 50. The processor 46, the RAM 48, and the storage 50 are connected to a bus 52. Also, the microphone 238, the speaker 240, the camera 42, and the display 343 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

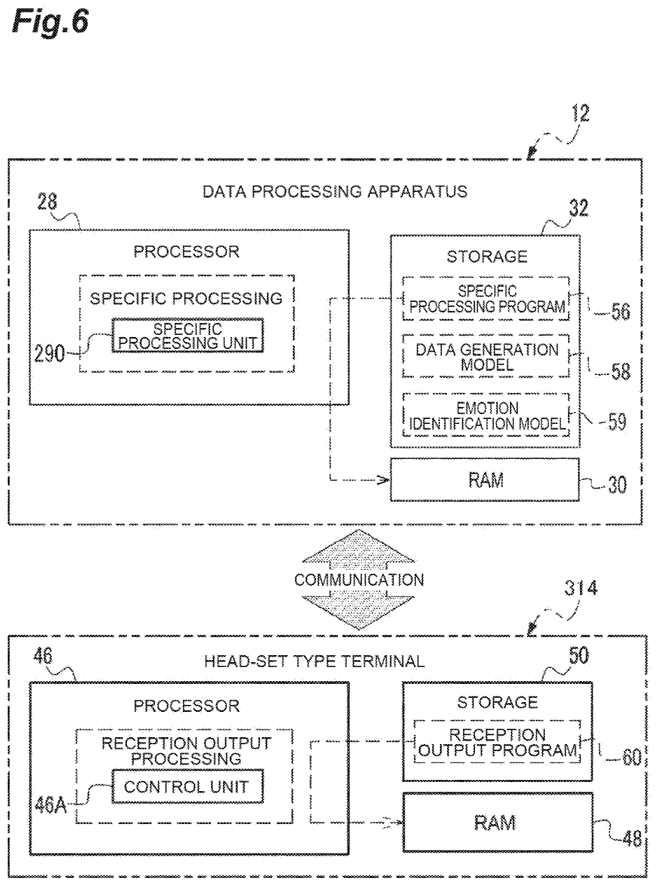

FIG. 6 illustrates an example of main functions of the data processing apparatus 12 and the headset-type terminal 314. As illustrated in FIG. 6, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the headset-type terminal 314, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the headset-type terminal 314. In the following description, the data processing apparatus 12 is referred to as a “server”, and the headset-type terminal 314 is referred to as a “terminal”.

### Example 1

Since the flow of the specific processing is the same as that in Example 1 described in the first embodiment, a description thereof is omitted.

### Application Example 1

Since the flow of the specific processing is the same as that in Example 1 described in the first embodiment, a description thereof is omitted.

The specific processing unit 290 transmits a result of the specific processing to the headset-type terminal 314. In the headset-type terminal 314, the control unit 46A causes the speaker 240 and the display 343 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL:https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the headset-type terminal 314.

### Fourth Embodiment

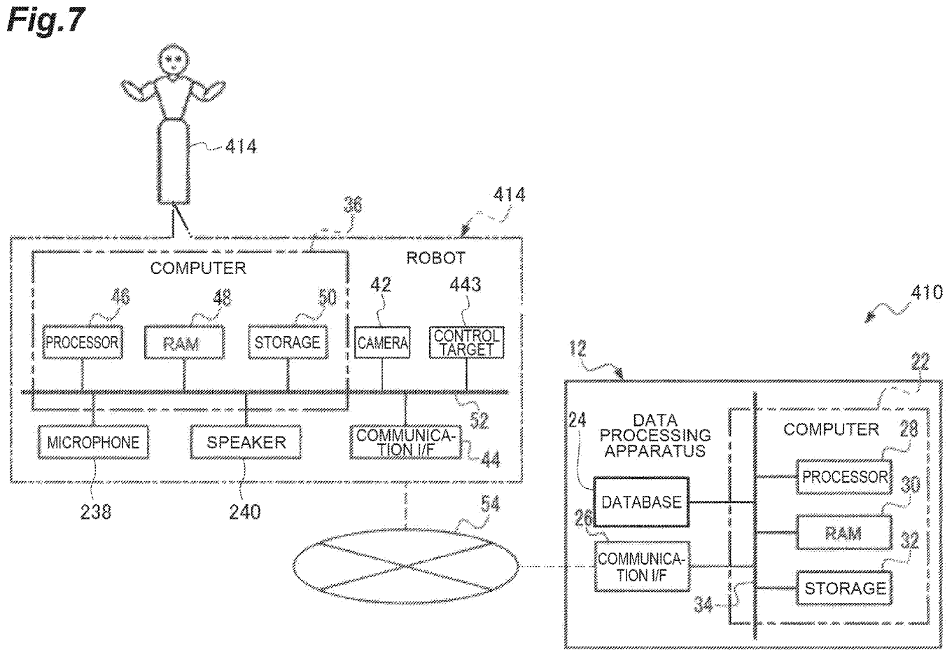

FIG. 7 illustrates an example of a configuration of a data processing system 410 according to a fourth embodiment.

As illustrated in FIG. 7, the data processing system 410 includes a data processing apparatus 12 and a robot 414. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The robot 414 includes a computer 36, a microphone 238, a speaker 240, a camera 42, a communication I/F 44, and a control target 443. The computer 36 includes a processor 46, a RAM 48, and a storage 50. The processor 46, the RAM 48, and the storage 50 are connected to a bus 52. Also, the microphone 238, the speaker 240, the camera 42, and the control target 443 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

The control target 443 includes a display device, an LED of an eye part, and motors that drive an arm, a hand, a leg, and the like. The posture and gestures of the robot 414 are controlled by controlling the motors of the arm, hand, leg, and the like. A part of the emotions of the robot 414 can be expressed by controlling these motors. Also, the facial expression of the robot 414 can also be expressed by controlling the light emission state of the LED of the eye part of the robot 414.

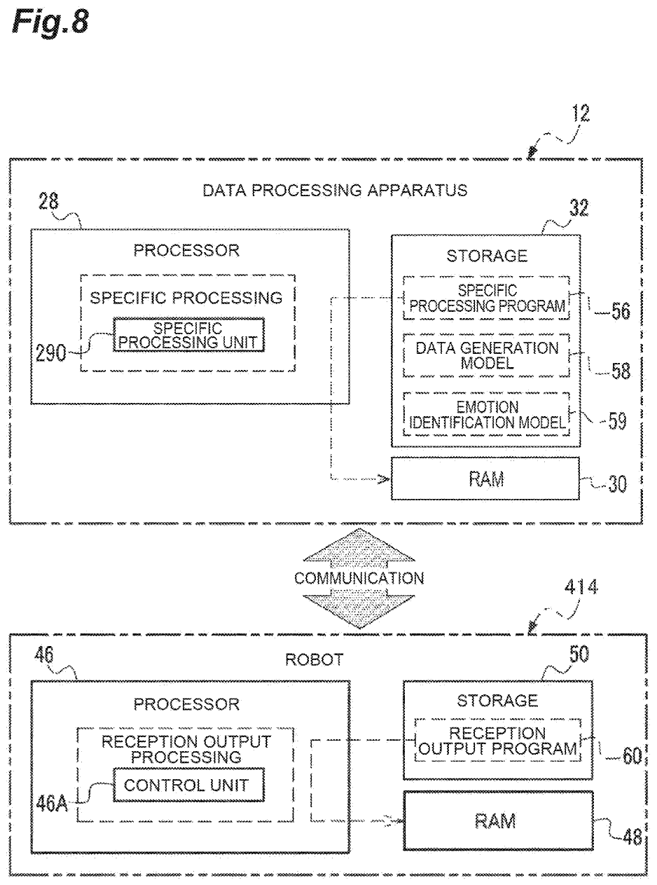

FIG. 8 illustrates an example of main functions of the data processing apparatus 12 and the robot 414. As illustrated in FIG. 8, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the robot 414, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the robot 414. In the following description, the data processing apparatus 12 is referred to as a “server”, and the robot 414 is referred to as a “terminal”.

### Example 1

Since the flow of the specific processing is the same as that in Example 1 described in the first embodiment, a description thereof is omitted.

### Application Example 1

Since the flow of the specific processing is the same as that in Example 1 described in the first embodiment, a description thereof is omitted.

The specific processing unit 290 transmits a result of the specific processing to the robot 414. In the robot 414, the control unit 46A causes the speaker 240 and the control target 443 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL:https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the robot 414.

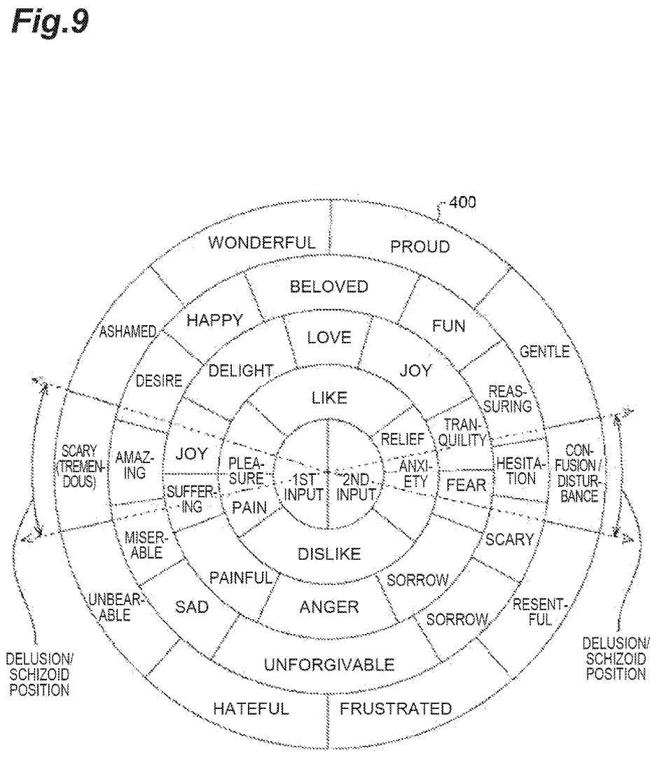

Note that the emotion identification model 59 as an emotion engine may determine a user's emotion according to a specific mapping. Specifically, the emotion identification model 59 may determine the user's emotion according to an emotion map (see FIG. 9), which is a specific mapping. Also, the emotion identification model 59 may similarly determine the robot's emotion, and the specific processing unit 290 may perform specific processing using the robot's emotion.

FIG. 9 is a diagram illustrating an emotion map 400 on which a plurality of emotions are mapped. In the emotion map 400, emotions are arranged in concentric circles radiating from the center. The closer to the center of the concentric circles, the more primitive the state of the emotion is arranged. On the outer side of the concentric circles, emotions representing states and actions arising from a state of mind are arranged. Emotion is a concept that also includes affect and mental states. On the left side of the concentric circles, emotions generated from reactions that generally occur in the brain are arranged. On the right side of the concentric circles, emotions that are generally induced by situational judgment are arranged. In the upward and downward directions of the concentric circles, emotions that are generated from reactions that generally occur in the brain and are induced by situational judgment are arranged. Also, on the upper side of the concentric circles, “pleasant” emotions are arranged, and on the lower side, “unpleasant” emotions are arranged. In this way, in the emotion map 400, a plurality of emotions are mapped based on the structure in which emotions are generated, and emotions that are likely to occur at the same time are mapped close to each other.

These emotions are distributed in the 3 o'clock direction of the emotion map 400, and usually go back and forth between relief and anxiety. In the right half of the emotion map 400, situational awareness is superior to internal sensations, resulting in a calm impression.

Since the inside of the emotion map 400 represents the inside of the mind and the outside of the emotion map 400 represents actions, the further one goes to the outside of the emotion map 400, the more visible (manifested in action) the emotion becomes.

Here, human emotions are based on various balances such as posture and blood sugar levels, and show a state of unpleasantness when those balances move away from the ideal, and a state of pleasantness when they approach the ideal. In robots, automobiles, motorcycles, and the like as well, emotions can be created based on various balances such as posture and remaining battery level, so as to show a state of unpleasantness when those balances move away from the ideal, and a state of pleasantness when they approach the ideal. The emotion map may be generated based on, for example, Dr. Mitsuyoshi's emotion map (Research on a speech emotion recognition and brain physiological signal analysis system of affect, Tokushima University, doctoral dissertation: https://ci.nii.ac.jp/naid/500000375379). In the left half of the emotion map, emotions belonging to a region called “reaction” where sensation is dominant are arranged. Also, in the right half of the emotion map, emotions belonging to a region called “situation” where situational awareness is dominant are arranged.

In the emotion map, two emotions that promote learning are defined. One is an emotion around the middle of negative “remorse” and “reflection” on the situation side. That is, it is when a negative emotion such as “I never want to feel this way again” or “I don't want to be scolded anymore” arises in the robot. The other is an emotion around positive “desire” on the reaction side. That is, it is when there is a positive feeling such as “I want more” or “I want to know more”.

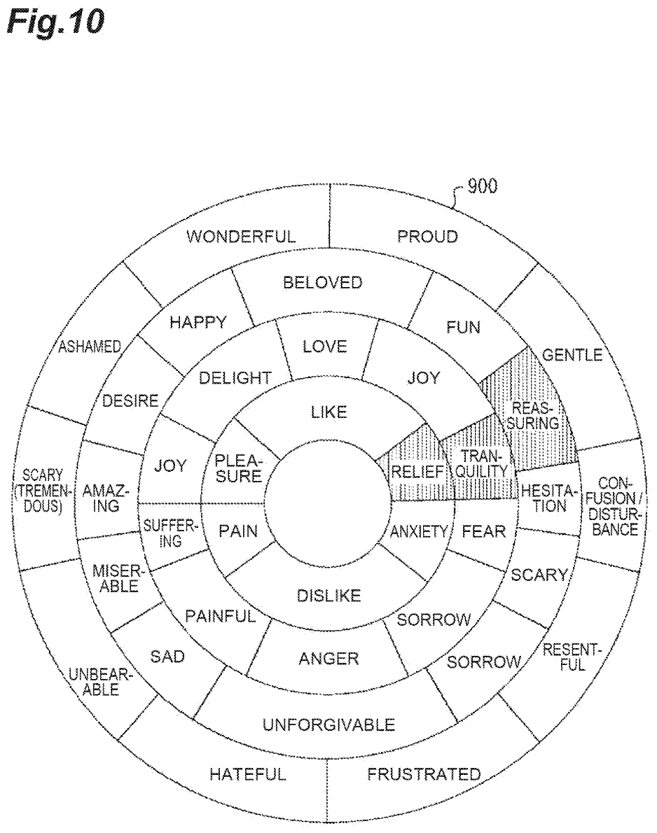

The emotion identification model 59 inputs a user input into a pre-trained neural network, acquires an emotion value indicating each emotion shown in the emotion map 400, and determines the user's emotion. This neural network is pre-trained based on a plurality of learning data that are combinations of user inputs and emotion values indicating each emotion shown in the emotion map 400. Also, this neural network is trained such that emotions arranged close to each other have close values, as in the emotion map 900 shown in FIG. 10. FIG. 10 shows an example in which a plurality of emotions, “relief,” “peace of mind,” and “reassured,” have close emotion values.

Although the system according to the present disclosure has been described above mainly with respect to the functions of the data processing apparatus 12, the system according to the present disclosure is not necessarily implemented in a server. The system according to the present disclosure may be implemented as a general information processing system. The present disclosure may be implemented as, for example, a software program that runs on a personal computer, or an application that runs on a smartphone or the like. The method according to the present disclosure may be provided to a user in a SaaS (Software as a Service) format.

In the above embodiment, an example form in which the specific processing is performed by one computer 22 has been described, but the technology of the present disclosure is not limited to this, and distributed processing for the specific processing may be performed by a plurality of computers including the computer 22. For example, the data generation model 58 may be provided in an external device of the data processing apparatus 12, and the external device may generate data according to the input data.

In the above embodiment, an example form in which the specific processing program 56 is stored in the storage 32 has been described, but the technology of the present disclosure is not limited to this. For example, the specific processing program 56 may be stored in a portable computer-readable non-transitory storage medium such as a USB (Universal Serial Bus) memory. The specific processing program 56 stored in the non-transitory storage medium is installed in the computer 22 of the data processing apparatus 12. The processor 28 executes the specific processing according to the specific processing program 56.

Also, the specific processing program 56 may be stored in a storage device such as a server connected to the data processing apparatus 12 via the network 54, and the specific processing program 56 may be downloaded in response to a request from the data processing apparatus 12 and installed in the computer 22.

Note that it is not necessary to store all of the specific processing program 56 in a storage device such as a server connected to the data processing apparatus 12 via the network 54, or to store all of the specific processing program 56 in the storage 32, and a part of the specific processing program 56 may be stored.

As hardware resources for executing the specific processing, various processors shown below can be used. Examples of the processor include a CPU, which is a general-purpose processor that functions as a hardware resource for executing the specific processing by executing software, that is, a program. Also, examples of the processor include a dedicated electric circuit, which is a processor having a circuit configuration specifically designed to execute specific processing, such as an FPGA (Field-Programmable Gate Array), a PLD (Programmable Logic Device), or an ASIC (Application Specific Integrated Circuit). A memory is built in or connected to any of the processors, and any of the processors executes the specific processing by using the memory.

The hardware resource that executes the specific processing may be configured by one of these various processors, or may be configured by a combination of two or more processors of the same type or different types (for example, a combination of a plurality of FPGAs, or a combination of a CPU and an FPGA). Also, the hardware resource that executes the specific processing may be one processor.

As an example of a configuration with one processor, first, there is a form in which one processor is configured by a combination of one or more CPUs and software, and this processor functions as a hardware resource for executing the specific processing. Second, there is a form in which a processor that realizes the functions of an entire system including a plurality of hardware resources for executing the specific processing with one IC chip, as represented by an SoC (System-on-a-chip) or the like, is used. In this way, the specific processing is realized using one or more of the various processors described above as hardware resources.

Furthermore, as a hardware structure of these various processors, more specifically, an electric circuit in which circuit elements such as semiconductor elements are combined can be used. Also, the specific processing described above is merely an example. Therefore, it goes without saying that unnecessary steps may be deleted, new steps may be added, or the processing order may be changed within a scope that does not depart from the gist.

The description and illustrations shown above are detailed descriptions of the parts related to the technology of the present disclosure, and are merely an example of the technology of the present disclosure. For example, the description regarding the above-described configuration, function, operation, and effect is a description regarding an example of the configuration, function, operation, and effect of the part related to the technology of the present disclosure. Therefore, it goes without saying that unnecessary parts may be deleted, new elements may be added, or replacements may be made to the description and illustrations shown above within a scope that does not depart from the gist of the technology of the present disclosure. Also, in order to avoid confusion and facilitate understanding of the parts related to the technology of the present disclosure, in the description and illustrations shown above, descriptions regarding common general technical knowledge and the like that do not require particular explanation for enabling the implementation of the technology of the present disclosure are omitted.

All documents, patent applications, and technical standards described in this specification are incorporated herein by reference to the same extent as if each individual document, patent application, and technical standard were specifically and individually indicated to be incorporated by reference.

Regarding the above embodiments, the following is further disclosed.

### Application Example 1

A management system for a logistics center, comprising an information processing unit, a data management unit, and a delivery planning unit, wherein the information processing unit has a function of collecting inventory data, shipping information, and traffic condition data within the logistics center, performing analysis using natural language processing technology, and generating optimal inventory placement, shipping instructions, and delivery routes, the data management unit is responsible for centrally managing various data within the logistics center and providing it to the information processing unit, and the delivery planning unit has a function of optimizing the operation of delivery vehicles based on the generated delivery routes.

The system, wherein the information processing unit generates a proposal for placing products so as to enable efficient picking based on the turnover rate and shipping frequency of products in the logistics center, and, for shipping instructions, determines an optimal shipping order according to order details to improve work efficiency.

The system, wherein the delivery planning unit considers traffic conditions, geographical information of delivery destinations, and the condition of delivery vehicles to generate an optimal delivery route, thereby realizing a reduction in delivery time and fuel costs.

An information processing system comprising: an AI model; and a circuit, wherein the AI model operates within an in-house network via a cloud service, and wherein the circuit is configured to: restrict access from outside using a virtual network; cause the AI model to read in-house information; receive an inquiry from an employee; analyze content of the inquiry via the AI model; generate a primary response; perform escalation of the inquiry for which the AI model fails to generate the primary response to an administrator terminal; and selectively perform the escalation to the administrator terminal when the AI model succeeds in generating the primary response.

The system, wherein the circuit is configured to: analyze the inquiry from the employee using natural language processing technology; generate the primary response based on the in-house information read in advance; and return the primary response to the employee within business hours.

The system, wherein the circuit is configured to: transfer the inquiry to the administrator terminal when the inquiry is an inquiry for which the AI model fails to generate the primary response, or in response to a request for escalation from the employee after the primary response is generated.

An information processing method comprising: restricting access from outside using a virtual network; causing an AI model to read in-house information, wherein the AI model operates within an in-house network via a cloud service; receiving an inquiry from an employee; analyzing content of the inquiry via the AI model; generating a primary response; performing escalation of the inquiry for which the AI model fails to generate the primary response to an administrator terminal; and selectively perform the escalation to the administrator terminal when the AI model succeeds in generating the primary response.

1. An information processing system comprising:
an AI model; and
a circuit,
wherein the AI model operates within an in-house network via a cloud service, and
wherein the circuit is configured to:
restrict access from outside using a virtual network;
cause the AI model to read in-house information;
receive an inquiry from an employee;
analyze content of the inquiry via the AI model;
generate a primary response;
perform escalation of the inquiry for which the AI model fails to generate the primary response to an administrator terminal; and
selectively perform the escalation to the administrator terminal when the AI model succeeds in generating the primary response.

2. The system according to claim 1,
wherein the circuit is configured to:
analyze the inquiry from the employee using natural language processing technology;
generate the primary response based on the in-house information read in advance; and
return the primary response to the employee within business hours.

3. The system according to claim 1,
wherein the circuit is configured to:
transfer the inquiry to the administrator terminal when the inquiry is an inquiry for which the AI model fails to generate the primary response, or in response to a request for escalation from the employee after the primary response is generated.

4. An information processing method comprising:
restricting access from outside using a virtual network;
causing an AI model to read in-house information, wherein the AI model operates within an in-house network via a cloud service;
receiving an inquiry from an employee;
analyzing content of the inquiry via the AI model;
generating a primary response;
performing escalation of the inquiry for which the AI model fails to generate the primary response to an administrator terminal; and
selectively perform the escalation to the administrator terminal when the AI model succeeds in generating the primary response.
